(19) United States
(12) Patent Application Publication
(10) Pub. No.: US 2011/0271582 A1
(43) Pub. Date: Nov. 10, 2011

(54) Snap Trap

(75) Inventors: Silvin Jancic, Villmergen (CH); Dennis Walstad, Elburn, IL (US); Gabriel Le Laidier, St. Gallen (CH)

(73) Assignee: SWISSINNO SOLUTIONS AG, St. Gallen (CH)

(21) Appl. No.: 13/058,379

(22) PCT Filed: Aug. 28, 2008
(86) PCT No.: PCT/EP2008/061324

§ 371 Date: Mar. 22, 2011

(51) Int. Cl. A01M 23/30

(52) U.S. Cl. 43/81

(57) ABSTRACT

A snap trap (1) for mice has a pivotable bar (3), which is mounted on a base plate (2) and is prestressed in a readiness position against the spring force of a spring element (5), has a locking lever (6) for fixing the bar (3) in the readiness position and has a triggering part (4), which is provided with a bait holder (11). The triggering part (4) is mounted on the base plate (2) in the manner of a rocker. The triggering part (4) is also formed from plastic as a one-piece moulding.

The invention relates to a snap trap for mice, rats or other small animals as claimed in the pre-characterizing clause of claim 1.

Snap traps have been known and commonly used for a long time. Generically comparable snap traps are, for example, disclosed in DE 20 348 45 or DE 821 877. The snap trap consists of a base plate, a snap bar, a pivotable tongue that serves as a triggering part, and a locking lever for fixing the bar in a readiness position. The bar is mounted pivotably on the base plate and can be pretensioned in a readiness position against the spring force of a leg spring. The tongue is made of wood, as is the base plate. The tongue is equipped with a wire holding bar into which the front free end of the locking lever can be inserted to tension the trap. As the movable tongue is connected to the base plate in a fixed fashion by an axle, it cannot be removed, for example to clean the bait holder. A further disadvantage is that the trigger arrangement consists of two individual parts (ie the tongue and the holding bar), resulting in a relatively complicated design of the trap. A certain dexterity is thus required to tension the trap and inadvertent triggerings can in practise often occur when setting the trap.

It is therefore an object of the present invention to avoid the disadvantages of the prior art and, in particular, to provide a snap trap which is distinguished by an optimized trigger arrangement. The triggering part can be manufactured in a simple and cost-effective manner. The triggering part can be disassembled simply and thus permit cleaning in a simple fashion.

These objects are achieved with a snap trap which has the features of claim 1.

The snap trap contains a pivotable bar mounted on the base plate. The bar can be located in the striking position in a front region and in the readiness position in a rear region of the base plate. The pivoting range, determined by the readiness position on the one hand and by the striking position on the other hand, can be approximately 180°. In order to tension the trap, the bar is pivoted out of the striking position (or rest position) by approximately 180° and fixed in the pivoted-out position by means of the locking lever. In this readiness position, the locking lever is connected detachably to the triggering part. When the triggering part is touched, for example by a mouse, the connection between the locking lever and the triggering part can be broken, as a result of which the mouse is struck by the backward pivoting bar. Because the triggering part is formed as a one-piece molding, further advantages are afforded. On the one hand, a molding of this type can be produced simply and inexpensively. The bait holder and the means, interacting with the locking lever, for fixing the readiness position can be integrally formed with the triggering part and preferably are made of the same material.

In a first embodiment, the triggering part can be mounted on the base plate in the manner of a rocker. This rocker-like triggering part can consist of a first and a second rocker segment, an edge being arranged between the first and second rocker segment, about which the triggering part can move in the manner of a rocker. In addition to reliable triggering, such a rocker also has the advantage that the handling of the trap can be simplified when setting it.

It can be particularly advantageous if the triggering part has a touch-sensitive first rocker segment which in the striking position is surrounded by the bar when viewed from above. By means of this arrangement, a high degree of efficiency is ensured in terms of the killing of mice or other small animals. Here the view from above is preferably determined by a viewing direction which extends parallel to the surface normal of an upper side of the base plate.

It can be particularly advantageous if the triggering part has a touch-sensitive first rocker segment and if, when the bar passes from the readiness position into the striking position, it can be guided past the first rocker segment. A bearing can be arranged for mounting the triggering part on an upper side of the base plate. Because the bearing is attached to the base plate in a simple manner, the production cost can be reduced further. The bearing can be made of wire. It can furthermore be advantageous if the bearing has a U-shaped design. The U-shaped bearing can have arms which run approximately parallel to each other and are embedded in a base plate that is preferably made of wood. A bearing of this type can, for example, be inserted in a wooden plate by being hammered in. The U-shaped bearing can moreover have an approximately rectangular configuration, wherein it can contain two arms and a crosspiece connecting said arms.

The triggering part can be fastened or be fastenable detachably to the base plate. This embodiment enables a particularly simple assembly and disassembly of the bait holder associated with the triggering part. It can thereby be particularly advantageous if the triggering part is or can be latched onto the bearing. Such a snap-on or latch connection has a positive effect on the handleability of the trap. The latch connection can, for example, be determined by the crosspiece of the U-shaped bearing on one side and by latching catch parts integrally formed on the triggering part on the other side.

The triggering mechanism can be improved if the triggering part has an engagement section against which a free end of the locking lever can be braced to determine the readiness position. The engagement section can for this purpose be provided with an undercut. The undercut allows a relatively secure temporary connection between the locking lever and the triggering part in the readiness position. A further advantage of this arrangement is that the readiness position can be obtained simply and with little manipulation as the two components of the triggering mechanism which correspond with each other can be connected to each other in a latching fashion. Such a design of the triggering mechanism can of course also be advantageous when used in combination with conventional mouse traps.

In a further embodiment, the triggering part can have a depression into which the locking lever can be introduced. That part of the locking lever which is introduced into the depression is thus not exposed. It is, to a certain extent, “hidden”, which can considerably reduce the risk of accidents. The depression can extend in a longitudinal direction determined by the locking lever as far as one end, wherein the engagement section for the locking lever can be arranged at this end. The depression can thus be designed in the manner of a channel. The depression can be arranged in the second rocker segment of the triggering part.

The spring element can be a leg spring with a spiral section. It can here be advantageous if the second rocker segment has a recess in which the spiral section can be accommodated. This recess can be designed in such a way that the second (or rear) rocker segment fits over the spiral section in each position, the rocker-like tilting movement of the triggering part thus not being affected.

From a production technology point of view, and for hygienic reasons, it can be advantageous if the triggering part is made of plastic. It can additionally be advantageous if the base plate is made of wood, or also of plastic.

Advantageous mass production can be achieved if the triggering part is a plastic injection-molded part.

The base plate can consist of a single wooden piece. Because no other components are made of wood, the assembling of the snap trap is simplified. The wooden piece can be cut in a simple fashion from a wooden board and does not need to be treated further on a large scale. In particular, no additional drilling or milling operations are required.

The efficiency of the trap can be further increased if the bar and/or a front region of the base plate that is associated with the striking position of the bar as well as, optionally, that region of the triggering part associated with the bait holder (for example, the first rocker segment) is curved in design, and is preferably approximately semicircular, when viewed from above. The curved shape has the advantage that small animals can be gripped relatively securely not only at the front in the middle but also when they approach the trap from the side to a greater or lesser degree. The curved shape of the base plate can offer advantages for generically comparable animal traps, even if the above-described triggering part that is a one-piece molding is not used.

Further advantages and individual features of the invention will become apparent from the drawings and the following description of exemplary embodiments. In the drawings:

FIG. 1 shows a perspective view of a snap trap according to the invention for mice, rats or other small animals in a rest or striking position,

FIG. 2 shows the snap trap according to FIG. 1 in the readiness position,

FIG. 3 shows a triggering part of the snap trap according to FIG. 1,

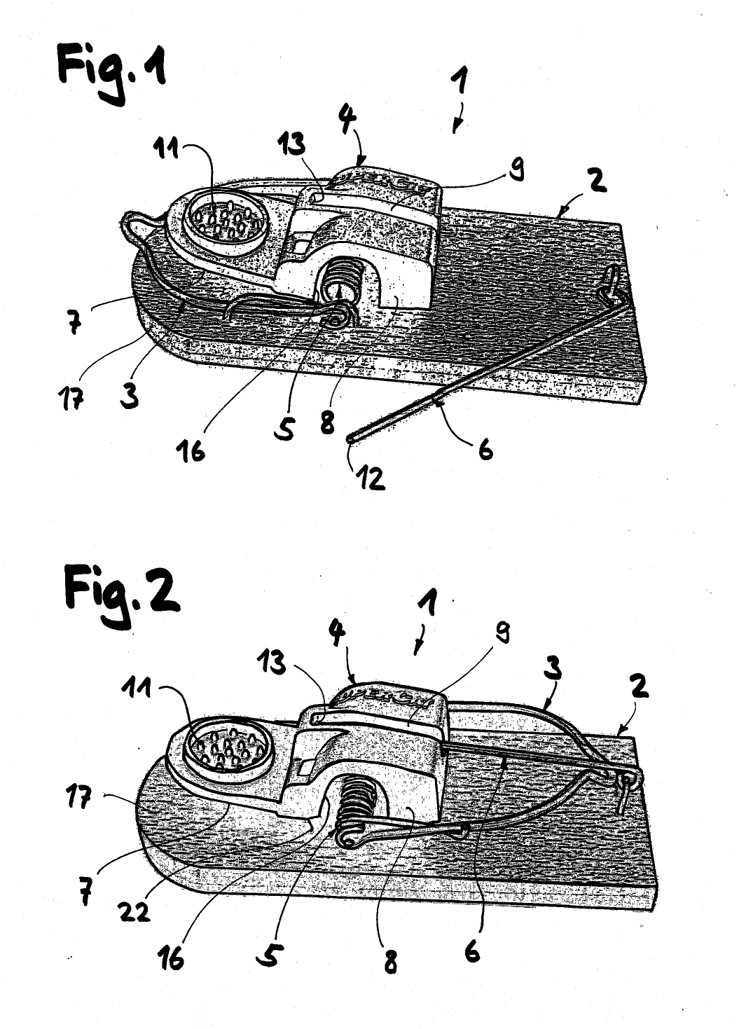

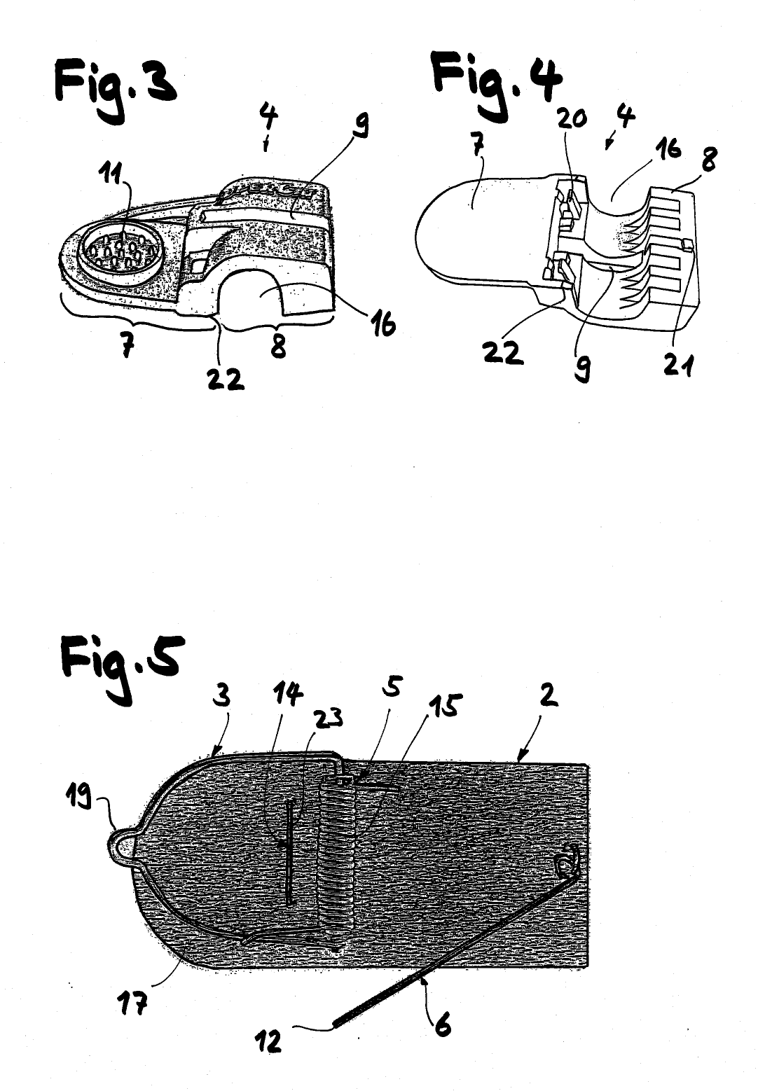

FIG. 4 shows the triggering part in a rear view, and

FIG. 5 shows a view from above of the animal trap according to FIG. 1 without the triggering part.

FIG. 1 shows a snap trap designated by 1 with which especially mice can be caught in an advantageous manner. The snap trap is, however, also suitable for catching rats or other small animals. As in known traditional snap traps, these small animals are killed when a bar snaps down on them.

The essential components of the snap trap 1 are: a base plate 2, a bar 3, a spring element 5, a triggering part 4 and a locking lever 6. The triggering part 4 is made of plastic, the base plate 2 is made of wood and the other components are each made of wire. The triggering part 4 is preferably an injection-molded plastic part. This one-piece molding forms a type of rocker with a first (or front) rocker segment 7 and a second (or rear) rocker segment 8. As shown in FIG. 2, the rear rocker segment 8 in the readiness position rests on the base plate 2, whereas the front rocker segment 7 projects somewhat from the upper side of the base plate. A touch-sensitive segment 8 is created by this arrangement which tilts the front segment 7 downwards when touched by a mouse that approaches the trap. At the same time, the rear segment 8 is moved upwards in a tilting movement, thereby triggering the trap. A bearing is arranged for mounting the triggering part 4 on the upper side of the base plate 2 (not shown here) (but cf FIG. 5). The bait holder 11 associated with the front rocker segment 7 contains a plurality of pimple-like protuberances for fixing bait.

A channel-like depression 9 can be seen in FIG. 1 which extends in the longitudinal direction as far as the end facing the front rocker segment 7. This end forms an engagement section which is provided with an undercut 13. The free end 12 of the locking lever 6 is braced against the engagement section 10 in the readiness position (cf FIG. 2). The undercut 13 here prevents unintentional triggering of the snap trap. As a result of the use according to the invention of the rocker-like triggering part 4 and of the undercut 13, the readiness position can be set simply and without a great deal of manipulation. The locking lever 6 has a free end 12 which can be braced against the engagement section of the triggering part 4 to determine the readiness position. The engagement section is arranged at the rear end of a depression 9 which is designed in the manner of a channel and extends as far as this end in a longitudinal direction determined by the locking lever 6 (cf FIG. 2). When the locking lever 6 is inserted, the detachable connection between the triggering part and the locking lever can be established automatically by the locking lever being locked in the depression 9 with the undercut 13. In FIG. 2, an edge can be seen which is designated by 22 and about which the triggering part 4 can be moved in the manner of a rocker. The edge 22 divides the triggering part 4 into the first rocker segment 7 and the second rocker segment 8.

FIG. 1 also shows that the touch-sensitive first rocker segment 7 is, seen from above, surrounded by the bar 3 in the striking position. When the bar 3 passes from the readiness position (FIG. 2) into the striking position (FIG. 1), the bar 3 can be guided past the first rocker segment 7. The second rocker segment 8 has a recess 16 in which a spiral section 15 of the spring element 5 can be accommodated. The bar 3 and that front region 17 of the base plate 2 which is associated with the striking position of the bar, as well as that region 7 of the triggering part 4 which is associated with the bait holder, are curved in design when viewed from above, and are in particular approximately semicircular.

As is apparent, for example, from FIG. 2, the spring element 5 is a leg spring, as in traditional snap traps (but see also the later FIG. 5). The leg spring has a spiral section 15 which is accommodated in a recess 16 of the triggering part 4. The bar 3 is connected to the spring element 5 in such a way that it is pretensioned in the readiness position against the spring force of the spring element. The locking lever 6 is articulated on the trap at the rear end of the base plate 2, in a similar fashion to traditional snap traps.

FIGS. 3 and 4 show the triggering part in a front and rear view. The triggering part 4 is latched or can be latched to the bearing 14. FIG. 4 shows latching catch parts 20 which are integrally formed on the triggering part and interact with a crosspiece of a U-shaped bearing to establish a latch connection (cf FIG. 5).

As shown in FIG. 5, the bar is approximately semicircular in design when viewed from above, a U-section 19 being integrally formed at the middle of the bar 3 and projecting relative to the semicircle. In the rest position, which corresponds to the striking position, the U-section 19 projects over the curved front region of the base plate 2, as a result of which the bar 3 can be easily gripped and folded back and tensioned. As is evident, the base plate 2 consists of a single wooden part. Also, a bearing 14 can be seen in FIG. 5 which serves for mounting the triggering part. The bearing 14 is made of wire and is arranged on the upper side of the base plate 2. The bearing 14 is U-shaped in design and has arms (not visible here) that run approximately parallel to each other and a crosspiece 23 connecting these arms, which are embedded in the base plate 2 made of wood. The crosspiece 23 serves as a counterpart for the latching catch parts of the triggering part.

1-21. (canceled)

22. A snap trap for mice, rats or other small animals with a bar which can pivot between a striking position and a readiness position, is mounted on a base plate and is or can be pretensioned against the spring force of a spring element in the readiness position, and with a locking lever which can be detachably connected to a triggering part containing a bait holder to fix the bar in the readiness position, wherein the triggering part is formed as a one-piece molding.

23. The snap trap as claimed in claim 22, wherein the triggering part is mounted on the base plate in the manner of a rocker.

24. The snap trap as claimed in claim 22, wherein the triggering part has a touch-sensitive first rocker segment that in the striking position is surrounded by the bar when viewed from above.

25. The snap trap as claimed in claim 22, wherein the triggering part has a touch-sensitive first rocker segment and that, when the bar passes from the readiness position into the striking position, it can be guided past the first rocker segment.

26. The snap trap as claimed in claim 22, wherein a bearing is arranged for mounting the triggering part on an upper side of the base plate.

27. The snap trap as claimed in claim 26, wherein the bearing is made of wire.

28. The snap trap as claimed in claim 26, wherein the bearing is U-shaped in design.

29. The snap trap as claimed in claim 26, wherein the U-shaped bearing has arms which run approximately parallel to each other and are embedded in a base plate that preferably is made of wood.

30. The snap trap as claimed in claim 22, wherein the triggering part is or can be fastened detachably to the base plate.

31. The snap trap as claimed in claim 26, wherein the triggering part is or can be latched onto the bearing.

32. The snap trap as claimed in claim 22, wherein the triggering part has an engagement section against which a free end of the locking lever can be braced to determine the readiness position.

33. The snap trap as claimed in claim 32, wherein the engagement section is provided with an undercut.

34. The snap trap as claimed in claim 32, wherein the triggering part has a depression into which the locking lever can be introduced.

35. The snap trap as claimed in claim 34, wherein the depression extends in a longitudinal direction determined by the locking lever as far as one end, the engagement section for the locking lever being arranged at the end.

36. The snap trap as claimed in claim 34, wherein the depression is designed in the manner of a channel.

37. The snap trap as claimed in claim 34, wherein the triggering part has a second rocker segment in which the depression is arranged.

38. The snap trap as claimed in claim 37, wherein the spring element is a leg spring containing a spiral section and that the second rocker segment has a recess in which the spiral section can be accommodated.

39. The snap trap as claimed in claim 22, wherein the triggering part is made of plastic and the base plate is made of plastic or wood.

40. The snap trap as claimed in claim 22, wherein the triggering part is a plastic injection-molded part.

41. The snap trap as claimed in claim 22, wherein the base plate consists of a single wooden part.

42. The snap trap as claimed in claim 22, wherein the bar and/or a front region of the base plate that is associated with the striking position of the bar as well as, optionally, that region of the triggering part associated with a bait holder is curved in design, and is preferably approximately semicircular, when viewed from above.
